(19) United States
(12) Patent Application Publication
(10) Pub. No.: US 2026/0259574 A1
(43) Pub. Date: Sep. 3, 2026

(54) FLOW RATE ADJUSTING DEVICE AND CONTROL METHOD OF FLOW RATE ADJUSTING DEVICE

(71) Applicant: Surpass Industry Co., Ltd., Gyoda-shi (JP)

(72) Inventor: Taku SHIBATA, Gyoda-shi (JP)

(73) Assignee: Surpass Industry Co., Ltd., Gyoda-shi (JP)

(21) Appl. No.: 19/540,325

(22) Filed: Feb. 13, 2026

(30) Foreign Application Priority Data
Feb. 28, 2025 (JP) 2025-031991

(51) Int. Cl. G05D 7/06; G01F 1/66; G01F 1/667; G01F 5/00

(52) U.S. Cl. CPC G05D 7/0635; G01F 1/662; G01F 1/667; G01F 5/00

(57) ABSTRACT

Provided is a control method of a flow rate adjusting device, and the control method includes: a flow rate adjusting step of controlling an flow rate adjusting portion to perform a flow rate adjusting operation so that a measured flow rate value of a liquid measured by an ultrasonic flow metering portion is a set flow rate value; an anomaly detecting step of detecting whether or not there is an abnormal state where the ultrasonic flow metering portion is unable to perform the flow rate measuring operation due to bubbles present in a measurement flow channel; and a bubble releasing step of: in response to the anomaly detecting step detecting presence of the abnormal state, controlling the flow rate adjusting portion to move the valve body by a predetermined distance in a direction away from the valve hole and then stop the valve body.

### CROSS-REFERENCE TO RELATED APPLICATIONS

This application claims foreign priority benefits under U.S.C. § 119 to Japanese Patent Application No. 2025-031991 filed on Feb. 28, 2025, the contents of which is hereby incorporated by reference in its entirety.

### BACKGROUND

### 1. Technical Field

The present disclosure relates to a flow rate adjusting device and a control method of a flow rate adjusting device.

### 2. Description of Related Art

Flow rate adjusting devices that includes a flow metering portion configured to measure the flow rate of a liquid and moves a valve body in a direction closer to or away from a valve hole to adjust the flow rate of a liquid passing through the valve hole so that the flow rate measured by the flow metering portion is a set flow rate set in advance are conventionally known (for example, see Japanese Patent Application Laid-Open No. 2017-138200).

The flow rate adjusting device disclosed in Japanese Patent Application Laid-Open No. 2017-138200 includes an ultrasonic flow metering portion that performs a flow rate measuring operation to measure a flow rate of a liquid flowing through a measurement flow channel based on a propagation time difference between ultrasonic waves oscillated by a pair of oscillators arranged upstream and downstream in the measurement flow channel through which the liquid flows.

If bubbles are included in a liquid flowing through the measurement flow channel, this may cause an abnormal state where the flow rate measuring operation is unable to be suitably performed due to bubbles present between the pair of oscillators of the ultrasonic flow metering portion. In such an abnormal state, for example, the flow rate of a liquid measured by the ultrasonic flow metering portion may be zero even when the liquid is flowing through the measurement flow channel.

In the abnormal state, when the flow rate measured by the ultrasonic flow metering portion is smaller than a set flow rate, a valve body may be moved in a direction away from a valve hole, and the opening may be excessively increased. In such a case, since the opening resulted when bubbles present in the measurement flow channel are released becomes excessively larger than the set flow rate, this may cause flow rate fluctuations such as a phenomenon in which a measured flow rate is temporarily larger than the set flow rate (i.e., overshoot) or a phenomenon in which periodical repetition occurs between a state where the measured flow rate is excessively larger than the set flow rate and a state where the measured flow rate is excessively smaller than the set flow rate (i.e., hunting).

For example, to prevent overshoot or hunting, it may be considered to stop the motion of the valve body in response to occurrence of an abnormal state where the flow rate measuring operation is unable to be suitably performed due to bubbles and thereby prevent the opening of the valve body from being excessively larger than the set flow rate. However, if the motion of the valve body is stopped in response to occurrence of an abnormal state, a state where bubbles are less likely to be released will be maintained when the opening of the valve body is small. In such a case, the state where the flow rate measuring operation is unable to be suitably performed will not be eliminated or will require a long time to be eliminated.

### SUMMARY

The present disclosure has been made in view of such circumstances, and an object is to provide a flow rate adjusting device and a control method of a flow rate adjusting device that, when an abnormal state occurs where an ultrasonic flow metering portion is unable to perform a flow rate measuring operation due to bubbles present in a measurement flow channel, can quickly eliminate the abnormal state and prevent a flow rate fluctuation from occurring.

To achieve the above object, the present disclosure employs the following solutions.

A flow rate adjusting device according to one aspect of the present disclosure includes: an ultrasonic flow metering portion configured to perform a flow rate measuring operation to measure a flow rate of a liquid flowing through a measurement flow channel based on a propagation time difference between ultrasonic waves oscillated by a pair of oscillators arranged upstream and downstream in the measurement flow channel, the liquid flowing through the measurement flow channel; a flow rate adjusting portion configured to move a valve body along an axis in a direction closer to or away from a valve hole to adjust a flow rate of a liquid flowing out of the measurement flow channel; a flow rate setting unit configured to set a set flow rate value of a liquid to be adjusted by the flow rate adjusting portion; a control unit configured to control the flow rate adjusting portion to perform a flow rate adjusting operation to move the valve body to a target position so that a measured flow rate value of a liquid measured by the ultrasonic flow metering portion is the set flow rate value, the target position varying in accordance with a flow rate difference between the measured flow rate value and the set flow rate value; and an anomaly detecting unit configured to detect whether or not there is an abnormal state where the ultrasonic flow metering portion is unable to perform the flow rate measuring operation due to a bubble present in the measurement flow channel, and in response to the anomaly detecting unit detecting presence of the abnormal state, the control unit controls the flow rate adjusting portion to move the valve body by a predetermined distance in a direction away from the valve hole and then stop the valve body.

According to the flow rate adjusting device of one aspect of the present disclosure, in response to the anomaly detecting unit detecting an abnormal state where the ultrasonic flow metering portion is unable to perform the flow rate measuring operation due to bubbles present in the measurement flow channel, the valve body is moved by the predetermined distance in a direction away from the valve hole, and the motion of the valve body is then stopped. Since the opening of the valve body is larger than the opening at the time of detection of the abnormal state, release of bubbles from the measurement flow channel is facilitated compared to a case where the opening of the valve body at the time of detection of the abnormal state is maintained, and the abnormal state can be quickly eliminated. Further, since the opening of the valve body is set regardless of a measurement result provided by the ultrasonic flow metering portion, it is possible to prevent a flow rate fluctuation from occurring due to an excessive increase in the opening of the valve body relative to the set flow rate value.

The flow rate adjusting device according to one aspect of the present disclosure may be configured such that the control unit controls the flow rate adjusting portion to stop performing the flow rate adjusting operation in response to the anomaly detecting unit detecting presence of the abnormal state and start performing the flow rate adjusting operation in response to the anomaly detecting unit detecting absence of the abnormal state.

According to the flow rate adjusting device of the present configuration, it is possible to suitably switch whether or not to perform the flow rate adjusting operation in accordance with whether or not the anomaly detecting unit detects the presence of an abnormal state.

The flow rate adjusting device according to one aspect of the present disclosure may be configured such that the control unit controls the flow rate adjusting portion so that the predetermined distance is longer as the set flow rate value set by the flow rate setting unit is smaller when the anomaly detecting unit detects presence of the abnormal state.

According to the flow rate adjusting device of the present configuration, the predetermined distance becomes longer for a smaller set flow rate value applied at detection of the presence of an abnormal state, and this makes it possible to suitably eliminate the phenomenon in which the opening of the valve body becomes smaller for a smaller set flow rate value and this makes bubbles less likely to be released from the measurement flow channel.

The flow rate adjusting device according to one aspect of the present disclosure may be configured such that, when the set flow rate value set by the flow rate setting unit is less than or equal to a predetermined value in response to the anomaly detecting unit detecting presence of the abnormal state, the control unit controls the flow rate adjusting portion to move the valve body by the predetermined distance in the direction away from the valve hole and then stop the valve body, and when the set flow rate value set by the flow rate setting unit is greater than the predetermined value in response to the anomaly detecting unit detecting presence of the abnormal state, the control unit controls the flow rate adjusting portion to stop the valve body without moving the valve body in the direction away from the valve hole.

According to the flow rate adjusting device of the present configuration, the valve body is moved by a predetermined distance in the direction away from the valve hole when the set flow rate value applied at detection of the presence of an abnormal state is less than or equal to a predetermined value, and this makes it possible to suitably eliminate the phenomenon in which the opening of the valve body is small for a set flow rate value less than or equal to the predetermined value and this makes bubbles less likely to be released from the measurement flow channel.

In a control method of a flow rate adjusting device according to one aspect of the present disclosure, the flow rate adjusting device includes an ultrasonic flow metering portion configured to perform a flow rate measuring operation to measure a flow rate of a liquid flowing through a measurement flow channel based on a propagation time difference between ultrasonic waves oscillated by a pair of oscillators arranged upstream and downstream in the measurement flow channel, the liquid flowing through the measurement flow channel, a flow rate adjusting portion configured to move a valve body along an axis in a direction closer to or away from a valve hole to adjust a flow rate of a liquid flowing out of the measurement flow channel, and a flow rate setting unit configured to set a set flow rate value of a liquid to be adjusted by the flow rate adjusting portion, and the control method includes: a flow rate adjusting step of controlling the flow rate adjusting portion to perform a flow rate adjusting operation to move the valve body to a target position so that a measured flow rate value of a liquid measured by the ultrasonic flow metering portion is the set flow rate value, the target position varying in accordance with a flow rate difference between the measured flow rate value and the set flow rate value; an anomaly detecting step of detecting whether or not there is an abnormal state where the ultrasonic flow metering portion is unable to perform the flow rate measuring operation due to a bubble present in the measurement flow channel; and a bubble releasing step of, in response to the anomaly detecting step detecting presence of the abnormal state, controlling the flow rate adjusting portion to move the valve body by a predetermined distance in a direction away from the valve hole and then stop the valve body.

According to the control method of the flow rate adjusting device of one aspect of the present disclosure, in response to the anomaly detecting step detecting an abnormal state where the ultrasonic flow metering portion is unable to perform the flow rate measuring operation due to bubbles present in the measurement flow channel, the valve body is moved by the predetermined distance in a direction away from the valve hole, and the motion of the valve body is then stopped. Since the opening of the valve body is larger than the opening at the time of detection of the abnormal state, release of bubbles from the measurement flow channel is facilitated compared to a case where the opening of the valve body at the time of detection of the abnormal state is maintained, and the abnormal state can be quickly eliminated. Further, since the opening of the valve body is set regardless of a measurement result provided by the ultrasonic flow metering portion, it is possible to prevent a flow rate fluctuation from occurring due to an excessive increase in the opening of the valve body relative to the set flow rate value.

The control method of the flow rate adjusting device according to one aspect of the present disclosure may be configured to include a flow rate adjustment suspending step of stopping performing the flow rate adjusting operation in response to the anomaly detecting step detecting presence of the abnormal state, and the flow rate adjusting step may start performing the flow rate adjusting operation in response to the anomaly detecting step detecting absence of the abnormal state.

According to the control method of the flow rate adjusting device of the present configuration, it is possible to suitably switch whether or not to perform the flow rate measuring operation in accordance with whether or not the anomaly detecting step detects the presence of an abnormal state.

The control method of the flow rate adjusting device according to one aspect of the present disclosure may be configured such that the bubble releasing step controls the flow rate adjusting portion so that the predetermined distance is longer as the set flow rate value set by the flow rate setting unit is smaller when the anomaly detecting step detects presence of the abnormal state.

According to the control method of the flow rate adjusting device of the present configuration, the predetermined distance becomes longer for a smaller set flow rate value applied at detection of the presence of an abnormal state, and this makes it possible to suitably eliminate the phenomenon in which the opening of the valve body becomes smaller for a smaller set flow rate value and this makes bubbles less likely to be released from the measurement flow channel.

The control method of the flow rate adjusting device according to one aspect of the present disclosure may be configured such that, when the set flow rate value set by the flow rate setting unit is less than or equal to a predetermined value in response to the anomaly detecting step detecting presence of the abnormal state, the bubble releasing step controls the flow rate adjusting portion to move the valve body by the predetermined distance in the direction away from the valve hole and then stop the valve body, and when the set flow rate value set by the flow rate setting unit is greater than the predetermined value in response to the anomaly detecting step detecting presence of the abnormal state, the bubble releasing step controls the flow rate adjusting portion to stop the valve body without moving the valve body in the direction away from the valve hole.

According to the control method of the flow rate adjusting device of the present configuration, the valve body is moved by a predetermined distance in the direction away from the valve hole when the set flow rate value applied at detection of the presence of an abnormal state is less than or equal to a predetermined value, and this makes it possible to suitably eliminate the phenomenon in which the opening is small for a set flow rate value less than or equal to the predetermined value and this makes bubbles less likely to be released from the measurement flow channel.

According to the present disclosure, it is possible to provide a flow rate adjusting device and a control method of a flow rate adjusting device that, when an abnormal state occurs where an ultrasonic flow metering portion is unable to perform a flow rate measuring operation due to bubbles present in a measurement flow channel, can quickly eliminate the abnormal state and prevent a flow rate fluctuation from occurring.

### BRIEF DESCRIPTION OF THE DRAWINGS

FIG. 1 is a partial longitudinal sectional view illustrating one embodiment of a flow rate adjusting device.

FIG. 2 is a partial longitudinal sectional view illustrating an ultrasonic flow metering portion illustrated in FIG. 1.

FIG. 3 is a partial longitudinal sectional view illustrating a flow rate adjusting portion and an outflow-side flow channel portion illustrated in FIG. 1.

FIG. 4 is a longitudinal sectional view illustrating an inflow-side flow channel portion and a pressure sensor illustrated in FIG. 1.

FIG. 5 is a block diagram illustrating a configuration of a control device.

FIG. 6 is a schematic configuration diagram illustrating a flow rate adjusting system in which the flow rate adjusting device is installed.

FIG. 7 is a flowchart illustrating the operation performed by the flow rate adjusting device.

FIG. 8 is a flowchart illustrating the operation in a bubble release mode.

FIG. 9 is a graph illustrating an example of a change in the opening of a valve body and a set flow rate value.

### DETAILED DESCRIPTION

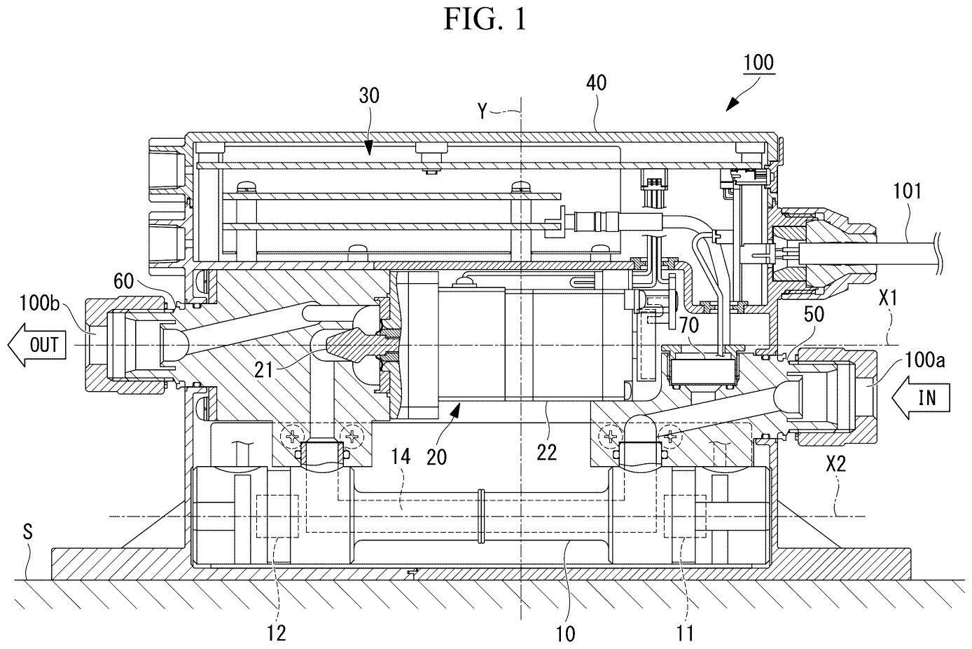

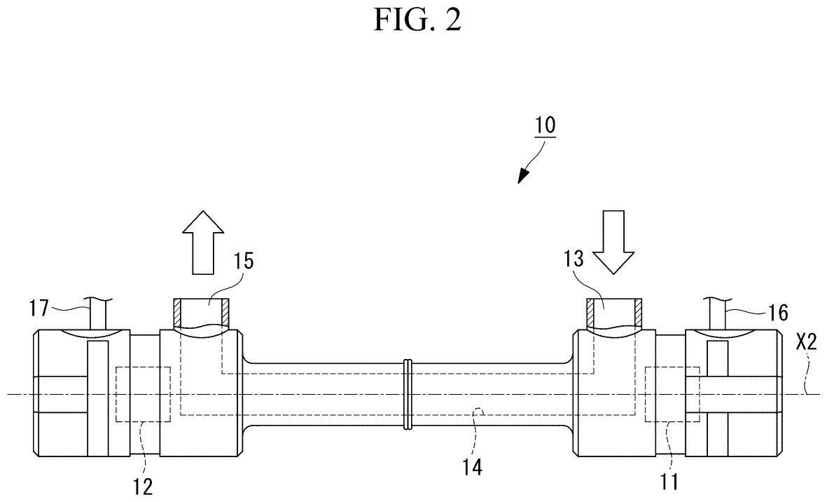

A flow rate adjusting device 100 of one embodiment of the present disclosure will be described below with reference to the drawings. FIG. 1 is a partial longitudinal sectional view illustrating one embodiment of the flow rate adjusting device 100. FIG. 2 is a partial longitudinal sectional view illustrating an ultrasonic flow metering portion 10 illustrated in FIG. 1.

The flow rate adjusting device 100 of this embodiment shown in FIG. 1 includes: an ultrasonic flow metering portion 10 which measures a flow rate of a liquid flowing in from an inflow port 100a and circulated through a straight tube-shaped measurement flow channel 14; a flow rate adjusting portion 20 which adjusts the flow rate of the liquid; a control device 30 which controls the flow rate adjusting portion 20; a housing portion 40 which accommodates the ultrasonic flow metering portion 10, the flow rate adjusting portion 20, the control device 30; an inflow-side flow channel portion 50 which guides the fluid flowing in from the inflow port 100a to an upstream side of the measurement flow channel 14; an outflow-side flow channel portion 60 which guides the fluid flowing out from a downstream side of the measurement flow channel 14 to an outflow port 100b; and a pressure sensor 70.

The fluid whose flow rate is adjusted by the flow rate adjusting device 100 of this embodiment is, for example, a drug solution (for example, hydrogen peroxide solution) or pure water used for semiconductor manufacturing devices. The temperature of the fluid is, for example, a temperature in an ordinary temperature range (for example, 10° C. or higher and lower than 40° C.) or a high-temperature range (for example, 50° C. or higher and 90° C. or lower).

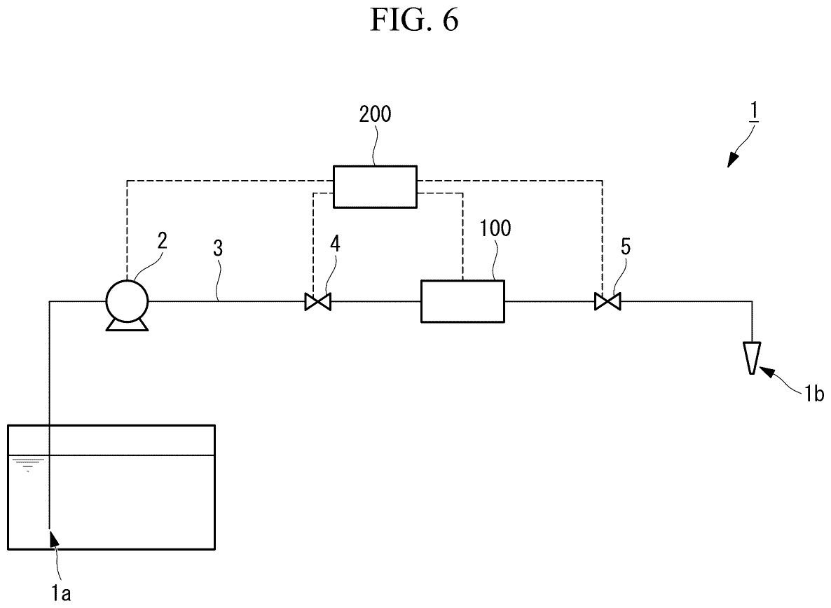

The housing portion 40 of the flow rate adjusting device 100 is fixed to an installation surface S with fastening bolts (not shown). The flow rate adjusting device 100 is connected to a higher-level device 200 (see FIG. 6) via a cable 101, is supplied with power from the external device via the cable 101, and transmits various signals to the higher-level device 200 and receives various signals therefrom.

Examples of the signals received from the higher-level device 200 include a flow rate setting signal indicating a set value of a target flow rate adjusted by the flow rate adjusting device 100. Examples of the signals transmitted to the higher-level device 200 include a signal indicating the flow rate of the liquid calculated by the control device 30 on the basis of s signal measured by the ultrasonic flow metering portion 10, and a signal indicating the pressure of the liquid measured by the pressure sensor 70.

The ultrasonic flow metering portion 10 measures a propagation time difference between ultrasonic wave signals transmitted by a pair of oscillators, i.e., an upstream side oscillator 11 disposed at the upstream side of the measurement flow channel 14 and a downstream side oscillator 12 disposed at the downstream side of the measurement flow channel 14, so as to obtain the flow rate of the liquid which flows in from an inflow-side pipe (not shown) and is circulated through the straight tube-shaped measurement flow channel 14. The ultrasonic flow metering portion 10 performs a flow rate measuring operation to measure a flow rate of the liquid flowing through the measurement flow channel 14 based on the propagation time difference.

As shown in FIG. 2, the ultrasonic flow metering portion 10 includes: the upstream side oscillator 11 and the downstream side oscillator 12 which are disposed on an axis line X2 that is parallel to the installation surface S; an inflow channel 13 which is connected to the inflow-side flow channel portion 50; the straight tube-shaped measurement flow channel 14 which is connected to the inflow channel 13 and extends along the axis line X2 (second axis line); and an outflow channel 15 which is connected to the outflow-side flow channel portion 60. The axis line X2 is parallel to an axis line X1 (first axis line) in which a valve body 21, which is described later, advances or recedes.

The upstream side oscillator 11 and the downstream side oscillator 12 are disposed at positions opposed to each other across the measurement flow channel 14 on the axis line X2, and can transmit and receive ultrasonic wave signals. The ultrasonic wave signal transmitted from the upstream side oscillator 11 propagates through the liquid circulated through the measurement flow channel 14 and is received by the downstream side oscillator 12.

Similarly, the ultrasonic wave signal transmitted from the downstream side oscillator 12 propagates through the liquid circulated through the measurement flow channel 14 and is received by the upstream side oscillator 11. Since the liquid is circulated through the measurement flow channel 14 from the upstream side to the downstream side, a propagation time for the ultrasonic wave signal transmitted from the upstream side oscillator 11 to the downstream side oscillator 12 is shorter than a propagation time for the ultrasonic wave signal transmitted from the downstream side oscillator 12 to the upstream side oscillator 11. The ultrasonic flow metering portion 10 measures the flow rate of the liquid circulated through the measurement flow channel 14 by using a difference between the propagation times.

Note that the transmission of the ultrasonic wave signals by the upstream side oscillator 11 and the downstream side oscillator 12 is controlled by the control device 30 which is connected to the upstream side oscillator 11 and the downstream side oscillator 12 with signal lines 16 and 17, respectively, which are shown in FIG. 2. The ultrasonic wave signals received by the upstream side oscillator 11 and the downstream side oscillator 12 are transmitted to the control device 30 via the signal lines 16 and 17. As described later, the control device 30 calculates a difference between propagation times from transmission timings for the ultrasonic wave signals that are sent as instructions to the upstream side oscillator 11 and the downstream side oscillator 12 and reception timings for the ultrasonic wave signals received from the upstream side oscillator 11 and the downstream side oscillator 12 according to the transmission timings, and also calculates the flow rate of the liquid from the calculated difference between propagation times.

The flow rate adjusting portion 20 adjusts the flow rate of the liquid flowing out to the outflow port 100b which is connected to an outflow-side pipe (not shown) via the outflow-side flow channel portion 60 from the downstream side of the measurement flow channel 14. As shown in FIG. 1, the flow rate adjusting portion 20 is disposed between the ultrasonic flow metering portion 10 and the control device 30 in an axis line Y direction corresponding to an installation direction orthogonal to the installation surface S. As shown in FIG. 1, in the axis line Y direction, the ultrasonic flow metering portion 10 is disposed at a position closest to the installation surface S, and the control device 30 is disposed at a position farthest from the installation surface S. The flow rate adjusting portion 20 is disposed between the ultrasonic flow metering portion 10 and the control device 30.

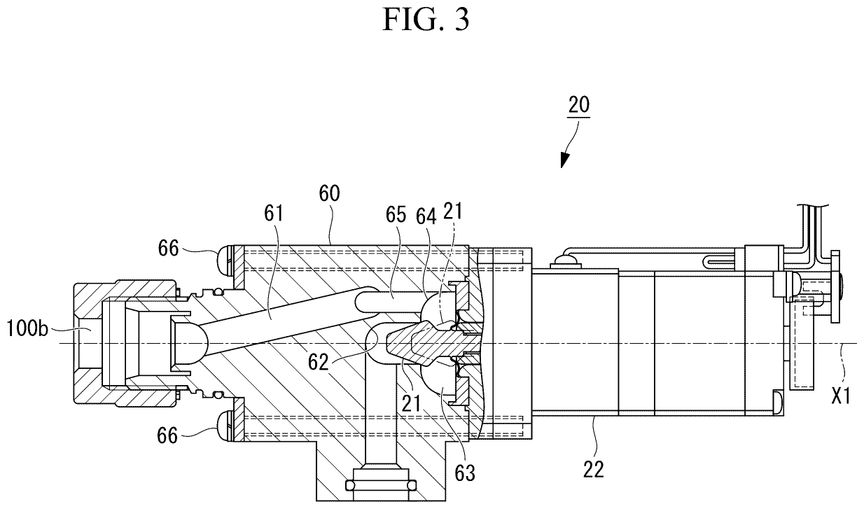

FIG. 3 is a partial longitudinal sectional view illustrating the flow rate adjusting portion 20 and the outflow-side flow channel portion 60 illustrated in FIG. 1. As illustrated in FIG. 3, the flow rate adjusting portion 20 has a valve body 21 inserted in a valve hole 62 formed in the outflow-side flow channel portion 60 and an electric drive portion 22 configured to move the valve body 21 in a direction closer to or away from the valve hole 62 along an axis X1 (first axis) parallel to the installation face S. The flow rate adjusting portion 20 moves the valve body 21 toward or away from the valve hole 62 along the axis X1 to adjust the flow rate of the liquid flowing out of the measurement flow channel 14.

The electric drive portion 22 moves the valve body 21 forward or backward along the axis X1 between a position of a closed state illustrated by the solid line in FIG. 3 and a position of an open state illustrated by the dashed line in FIG. 3. The flow rate adjusting portion 20 adjusts the amount of a fluid flowing into the valve chamber 63 from the valve hole 62 by adjusting the position of the valve body 21 on the axis X1 by the electric drive portion 22.

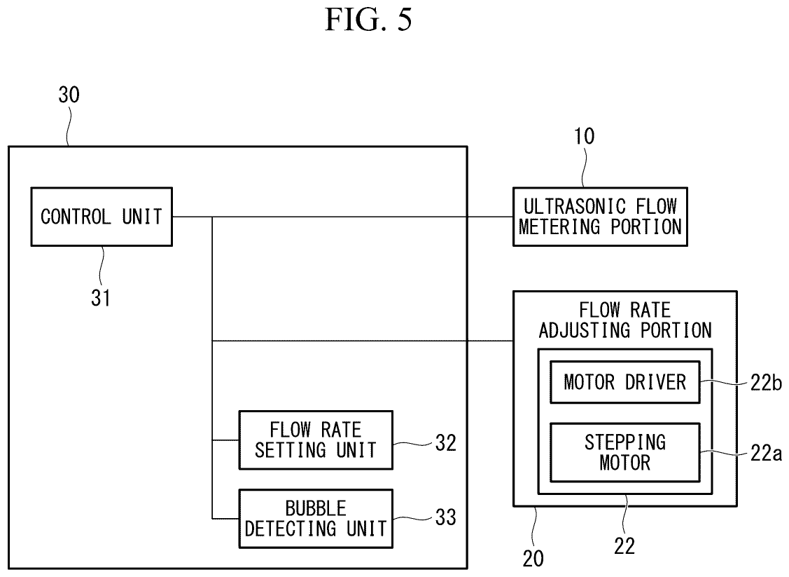

Herein, the configuration of the control device 30 will be described with reference to FIG. 5. FIG. 5 is a block diagram illustrating the configuration of the control device 30. As illustrated in FIG. 5, the control device 30 has a control unit 31, a flow rate setting unit 32, and a bubble detecting unit (anomaly detecting unit) 33. The control unit 31 controls the ultrasonic flow metering portion 10, the flow rate adjusting portion 20, the flow rate setting unit 32, and the bubble detecting unit 33.

The control unit 31 controls the flow rate adjusting portion 20 based on a measured flow rate value FRac of a liquid measured by the ultrasonic flow metering portion 10. The control unit 31 controls the flow rate adjusting portion 20 in one of a flow rate adjusting mode, a bubble release mode, and a standby mode.

When performing the flow rate adjusting mode, the control unit 31 controls the flow rate adjusting portion 20 to move the valve body 21 to a target position that varies in accordance with a flow rate difference between a measured flow rate value FRac measured by the ultrasonic flow metering portion 10 and a set flow rate value FRset set by the flow rate setting unit 32, so that the measured flow rate value FRac matches the set flow rate value FRset.

The control unit 31 controls the flow rate adjusting portion 20 so as to perform a bubble release mode when the bubble detecting unit 33 has detected the presence of an abnormal state described later. The control unit 31 controls the flow rate adjusting portion 20 so as to move the valve body 21 by a predetermined distance in a direction away from the valve hole 62 in response to the bubble detecting unit 33 detecting the presence of an abnormal state and then stop the valve body 21.

The bubble detecting unit 33 detects whether or not there is an abnormal state where the ultrasonic flow metering portion 10 is unable to perform the flow rate measuring operation due to bubbles present in the measurement flow channel 14. When bubbles are present in the measurement flow channel 14, the downstream oscillator 12 is unable to receive a signal transmitted by the upstream oscillator 11, and the upstream oscillator 11 is unable to receive a signal transmitted by the downstream oscillator 12.

Herein, the case where the downstream oscillator 12 is unable to receive a signal transmitted by the upstream oscillator 11 includes a case where a signal transmitted by the upstream oscillator 11 attenuates due to bubbles and the level of the signal falls below a receivable signal level of the downstream oscillator 12 and a case where transfer of a signal transmitted by the upstream oscillator 11 is delayed due to the effect of bubbles and does not reach the downstream oscillator 12 within a predetermined time from the transmission.

Similarly, the case where the upstream oscillator 11 is unable to receive a signal transmitted by the downstream oscillator 12 includes a case where a signal transmitted by the downstream oscillator 12 attenuates due to bubbles and the level of the signal falls below a receivable signal level of the upstream oscillator 11 and a case where transfer of a signal transmitted by the downstream oscillator 12 is delayed due to the effect of bubbles and does not reach the upstream oscillator 11 within a predetermined time from the transmission.

The ultrasonic flow metering portion 10 is operated such that the upstream oscillator 11 and the downstream oscillator 12 alternatingly repeat transmission and reception. In performing such an operation, the bubble detecting unit 33 detects that there is an abnormal state when the downstream oscillator 12 is unable to receive a signal transmitted by the upstream oscillator 11 or when the upstream oscillator 11 is unable to receive a signal transmitted by the downstream oscillator 12. The reason for moving the valve body 21 by a predetermined distance in the direction away from the valve hole 62 in response to the bubble detecting unit 33 detecting the presence of an abnormal state is to facilitate bubbles present in the measurement flow channel 14 to be released downstream of the measurement flow channel 14.

The control unit 31 sets the predetermined distance D by which the valve body 21 is moved in response to the bubble detecting unit 33 detecting the presence of an abnormal state based on Equation (1) and Equation (2) below.

$$O = - O max \times FRset / FR max + O max \qquad ( 1 )$$

$$D = O \times X max \qquad ( 2 )$$

Herein, Xmax represents a distance from a position on the axis X1 at which the valve body 21 is in contact with the valve hole 62 to a position of the valve body 21 on the axis X1 corresponding to the maximum flow rate FRmax of the set flow rate value FRset that can be set by the flow rate setting unit 32, O represents a rate of the opening [%] of the valve body 21 to be increased when the bubble detecting unit 33 has detected the presence of an abnormal state, and Omax represents the maximum value of O. For example, Omax is set to 0.2.

As expressed by Equation (1) and Equation (2), when the set flow rate value FRset is the maximum flow rate FRmax, the predetermined distance D is zero. That is, when the set flow rate value FRset is the maximum flow rate FRmax, the valve body 21 is already present near Xmin corresponding to the maximum opening. Thus, since it is not necessary to further increase the opening of the valve body 21 for releasing bubbles, the predetermined distance D is zero. Further, as expressed by Equation (1) and Equation (2), the predetermined distance D is longer for a smaller set flow rate value FRset that is set by the flow rate setting unit 32. This is for eliminating a state where, as the set flow rate value FRset is smaller, the opening of the valve body 21 is smaller and bubbles are less likely to be released.

The control unit 31 performs a standby mode when performing neither the flow rate adjusting mode nor the bubble release mode. When performing the standby mode, the control unit 31 controls the flow rate adjusting portion 20 to move the valve body 21 to a standby position at which the valve body 21 is not in contact with the valve hole 62 and then maintain the standby position. The control unit 31 sets the standby position to a predetermined position between a closed position (lower limit position), which corresponds to FRmin (lower limit value) that is the minimum flow rate of the set flow rate value FRset that can be set by the flow rate setting unit 32, and the upper limit position, which corresponds to the maximum flow rate FRmax (upper limit value) of the set flow rate value FRset that can be set by the flow rate setting unit 32.

The control unit 31 can instruct the upstream side oscillator 11 and the downstream side oscillator 12, respectively, which are included in the ultrasonic flow metering portion 10, to transmit ultrasonic wave signals. Further, the control unit 31 can detect a timing when the ultrasonic wave signal transmitted from one of the upstream side oscillator 11 and the downstream side oscillator 12 is received by the other one of the upstream side oscillator 11 and the downstream side oscillator 12.

The control unit 31 calculates a first propagation time from the transmission timing for the ultrasonic wave signal that is sent as an instruction to the downstream side oscillator 12 and the reception timing for the ultrasonic wave signal received by the upstream side oscillator 11 according to the transmission timing. Further, the control device 30 calculates a second propagation time from the transmission timing for the ultrasonic wave signal that is sent as an instruction to the upstream side oscillator 11 and the reception timing for the ultrasonic wave signal received by the downstream side oscillator 12 according to the transmission timing. The control unit 31 obtains the flow rate of the liquid circulated through the measurement flow channel 14 on the basis of a predetermined flow rate arithmetic expression and a propagation time difference obtained by subtracting the second propagation time from the first propagation time.

The flow rate setting unit 32 sets a set flow rate value FRset [ml/min] included in a flow rate range of the minimum flow rate, 0 [ml/min], to the maximum flow rate FRmax [ml/min] of the flow rate adjusting device 100. For example, the flow rate setting unit 32 sets the set flow rate value FRset based on a flow rate setting signal received by the control device 30 from the higher-level device 200 via the cable 101.

The electric drive portion 22 of the flow rate adjusting portion 20 has a stepping motor 22a that rotates about the axis X1 to move the valve body 21 along the axis X1 and a motor driver 22b that generates excitation current used for driving the stepping motor 22a and outputs the excitation current to the stepping motor 22a.

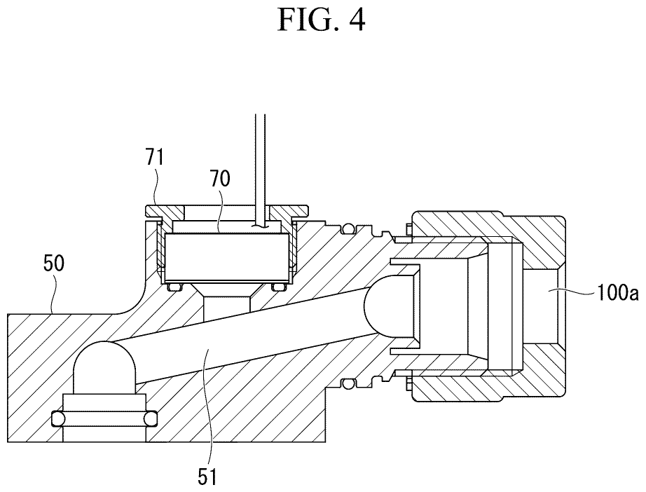

FIG. 4 is a longitudinal sectional view illustrating the inflow-side flow channel portion 50 and the pressure sensor 70 illustrated in FIG. 1. As shown in FIGS. 1 and 4, the inflow-side flow channel portion 50 is a member in which an inflow-side inclined flow channel 51 that is inclined in a direction approaching the installation surface S from the inflow port 100a to the upstream side inflow channel 13 of the measurement flow channel 14 is formed inside. The inflow-side flow channel portion 50 is provided with the pressure sensor 70 for detecting the pressure of the liquid circulated through the inflow-side inclined flow channel 51.

As shown in FIGS. 1 and 3, the outflow-side flow channel portion 60 is a member in which an outflow-side inclined flow channel 61 that is inclined in a direction approaching the installation surface S from the flow rate adjusting portion 20 to the outflow port 100b is formed inside. The outflow-side flow channel portion 60 guides the fluid to the upstream side of the outflow-side inclined flow channel 61 via an outflow channel 65 from an opening 64 that is formed at an upper portion of the valve chamber 63.

The liquid guided to the upstream side of the outflow-side inclined flow channel 61 is further guided to the outflow port 100b along the outflow-side inclined flow channel 61. As shown in FIGS. 2 and 3, the outflow-side flow channel portion 60 is provided with through-holes through which a plurality of fastening bolts 66 penetrate. The outflow-side flow channel portion 60 is fixed to the electric driving portion 22 by fastening the fastening bolts 66 to the electric driving portion 22.

The pressure sensor 70 measures the pressure (supply pressure) of the liquid flowing into the inflow-side inclined flow channel 51 at the upstream side of the measurement flow channel 14 from the inflow port 100a. The pressure sensor 70 is, for example, a strain gauge pressure sensor. As shown in FIG. 4, the pressure sensor 70 is attached to the inflow-side flow channel portion 50 by a sensor holder 71. A pressure signal indicating the pressure of the liquid measured by the pressure sensor 70 is transmitted to the control device 30 and stored in a storage portion (not shown) included in the control device 30. The pressure signal is transmitted to the higher-level device 200 via the cable 101.

Next, a flow rate adjusting system 1 in which the flow rate adjusting device 100 of the present embodiment is installed will be described with reference to FIG. 6. FIG. 6 is a schematic configuration diagram illustrating the flow rate adjusting system 1 in which the flow rate adjusting device 100 is installed. As illustrated in FIG. 6, the flow rate adjusting system 1 has a pump 2 configured to pressurize and feed a liquid, a piping 3 configured to convey a liquid from an inflow end 1a to an outflow end 1b, the flow rate adjusting device 100, an on-off valve 4 arranged in the piping 3 upstream of the flow rate adjusting device 100, an on-off valve 5 arranged in the piping 3 downstream of the flow rate adjusting device 100, and a higher-level device 200. The higher-level device 200 is a device that controls the flow rate adjusting device 100, the pump 2, the on-off valve 4, and the on-off valve 5.

The flow rate adjusting system 1 causes the pump 2 to pressurize and feed a liquid flowing into the piping 3 from the inflow end 1a to supply the fluid to the flow rate adjusting device 100 and supplies the fluid with the flow rate adjusted by the flow rate adjusting device 100 to the outflow end 1b. A state where a liquid is supplied from the inflow end 1a to the flow rate adjusting device 100 and a state where no fluid is supplied from the inflow end 1a to the flow rate adjusting device 100 are switched therebetween by the on-off valve 4. A state where a liquid is supplied from the flow rate adjusting device 100 to the outflow end 1b and a state where no liquid is supplied from the flow rate adjusting device 100 to the outflow end 1b are switched therebetween by the on-off valve 5.

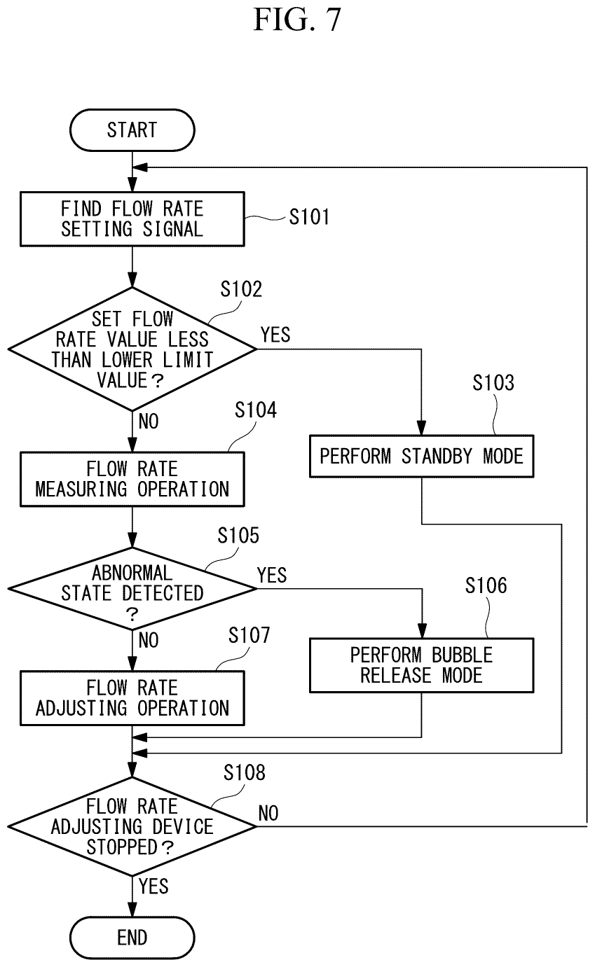

Next, the process performed by the flow rate adjusting device 100 of the present embodiment will be described with reference to FIG. 7. FIG. 7 is a flowchart illustrating the operation performed by the flow rate adjusting device 100.

In step S101, the control unit 31 finds a flow rate setting signal received from the higher-level device 200 and recognizes the set flow rate value FRset set by the flow rate setting signal.

In step S102, the control unit 31 determines whether or not the set flow rate value FRset is less than FRmin (lower limit value) and, if the determination is YES, proceeds with the process of step S103 or, if the determination is NO, proceeds with the process of step S104.

In step S103, the control unit 31 performs the standby mode. When performing the standby mode, the control unit 31 controls the flow rate adjusting portion 20 to move the valve body 21 to a standby position at which the valve body 21 is not in contact with the valve hole 62 and then maintain the standby position.

In step S104, the control unit 31 controls the ultrasonic flow metering portion 10 to perform a flow rate measuring operation. The ultrasonic flow metering portion 10 performs the flow rate measuring operation to measure the flow rate of a liquid flowing through the measurement flow channel 14 based on a propagation time difference between ultrasonic signals transmitted by the pair of oscillators.

In step S105, the control unit 31 determines whether or not the bubble detecting unit 33 detects the presence of an abnormal state where the ultrasonic flow metering portion 10 is unable to perform the flow rate measuring operation due to bubbles present in the measurement flow channel 14 and, if the determination is YES, proceeds with the process of step S106 or, if the determination is NO, proceeds with the process of step S107. In step S106, the control unit 31 performs the bubble release mode. The bubble release mode will be described later.

In step S107, the control unit 31 controls the flow rate adjusting portion 20 to perform a flow rate adjusting operation. The control unit 31 controls the flow rate adjusting portion 20 to move the valve body 21 to a target position, which varies in accordance with a flow rate difference between the measured flow rate value FRac and the set flow rate value FRset, so that the measured flow rate value FRac of the liquid measured by the ultrasonic flow metering portion 10 becomes the set flow rate value FRset set by the flow rate setting unit 32.

In step S108, the control unit 31 determines whether or not to stop the flow rate adjusting device 100 and, if the determination is YES, ends the process of the present flowchart or, if the determination is NO, performs step S101 again.

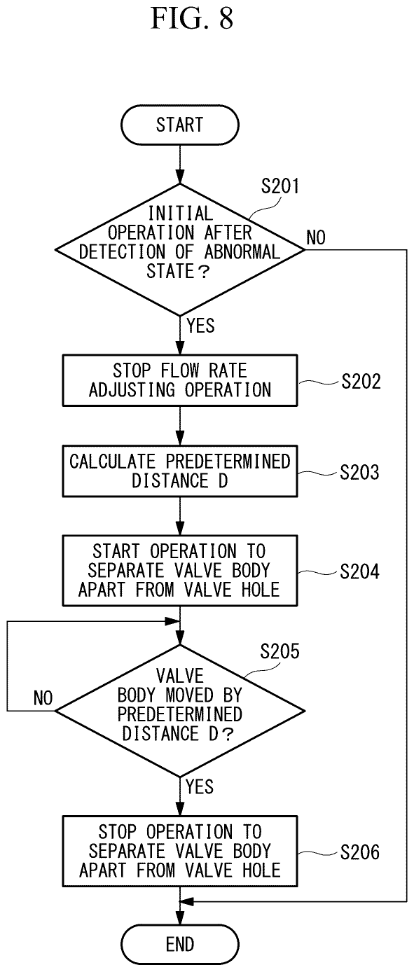

Next, the bubble release mode performed in step S106 of FIG. 7 will be described with reference to FIG. 8. FIG. 8 is a flowchart illustrating the operation of the bubble release mode.

In step S201, the control unit 31 determines whether or not the current operation is the initial operation after the bubble detecting unit 33 has detected the presence of an abnormal state and, if the determination is YES, proceeds with the process to step S202 or, if the determination is NO, ends the process of the present flowchart.

In step S202, the control unit 31 controls the flow rate adjusting portion 20 to stop the flow rate adjusting operation if the flow rate adjusting operation is being performed.

In step S203, the control unit 31 inputs the set flow rate value FRset, which has been found in step S101 of FIG. 7, to Equation (1) to calculate the predetermined distance D. The control unit 31 calculates the number of pulses to be output from the motor driver 22b to the stepping motor 22a as the predetermined distance D. This number of pulses is a numerical value used for moving the valve body 21 by the predetermined distance D along the axis X1.

In step S204, the control unit 31 controls the flow rate adjusting portion 20 to start an operation to separate the valve body 21 apart from the valve hole 62. The control unit 31 controls the flow rate adjusting portion 20 to start output of the pulses used by the motor driver 22b for driving the stepping motor 22a.

In step S205, the control unit 31 determines whether or not the motion by the predetermined distance D in the direction away from the valve hole 62 is completed with respect to the position of the valve body 21 at the time the bubble detecting unit 33 detected the detection of the presence of the abnormal state in step S105 and, if the determination is YES, proceeds with the process to step S206 or, if the determination is NO, repeatedly performs the determination of step S205. The control unit 31 determines YES when the number of pulses for moving the valve body 21 by the predetermined distance D is output from the motor driver 22b to the stepping motor 22a.

In step S206, the control unit 31 controls the flow rate adjusting portion 20 to stop the operation to separate the valve body 21 apart from the valve hole 62. The control unit 31 controls the flow rate adjusting portion 20 to stop the output of pulses used by the motor driver 22b for driving the stepping motor 22a.

As described above in FIG. 7 and FIG. 8, the control unit 31 controls the flow rate adjusting portion 20 to stop performing the flow rate adjusting operation (S202) in response to the bubble detecting unit 33 detecting the presence of an abnormal state in step S105 and start performing the flow rate adjusting operation (S107) in response to the bubble detecting unit 33 detecting the absence of an abnormal state in step S105.

Further, the control unit 31 calculates the predetermined distance D in step S203 by using Equation (1) and thereby controls the flow rate adjusting portion 20 so that the predetermined distance D is longer for a smaller set flow rate value FRset set by the flow rate setting unit 32 when the bubble detecting unit 33 has detected the presence of an abnormal state.

Note that, although the predetermined distance D is calculated from Equation (1) in the above description, other forms may be employed. For example, the control unit 31 may calculate the predetermined distance D to be a predefined value greater than zero when the set flow rate value FRset is less than or equal to a predetermined value and calculate the predetermined distance D to be zero when the set flow rate value FRset is greater than the predetermined value. In such a case, the control unit 31 controls the flow rate adjusting portion 20 to: move the valve body 21 by the predetermined distance D in the direction away from the valve hole 62 and then stop the valve body 21 when the set flow rate value FRset set by the flow rate setting unit 32 is less than or equal to the predetermined value in response to the bubble detecting unit 33 detecting the presence of an abnormal state; and stop the valve body 21 without moving the valve body 21 in the direction away from the valve hole 62 when the set flow rate value FRset set by the flow rate setting unit 32 is greater than the predetermined value in response to the bubble detecting unit 33 detecting the presence of an abnormal state.

Next, an example of performing the operations illustrated in FIG. 7 and

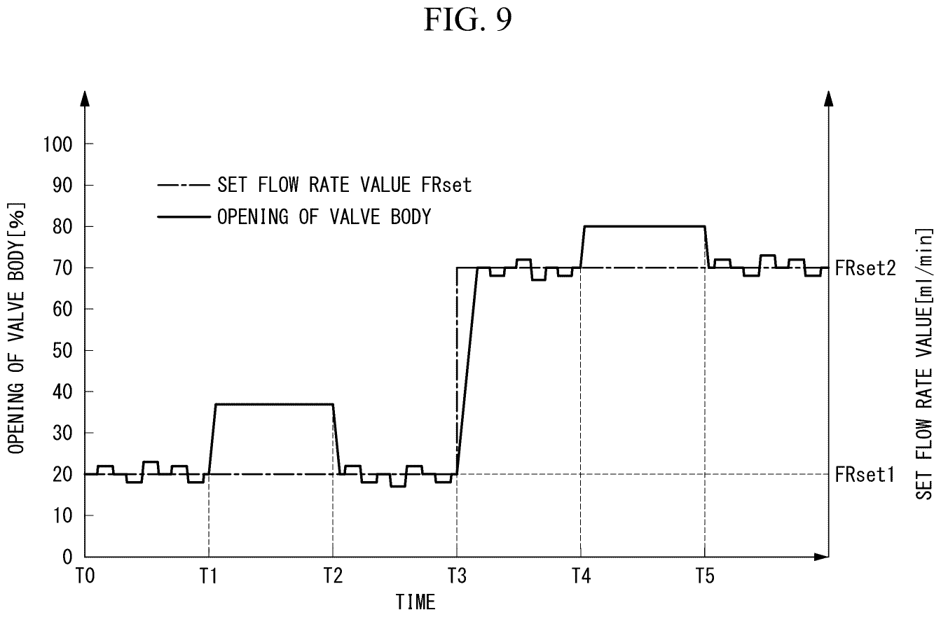

FIG. 8 will be described with reference to FIG. 9. FIG. 9 is a graph illustrating a change in the opening of the valve body 21 and the set flow rate value FRset. The opening of the valve body 21 is 100% for the position of the valve body 21 corresponding to the maximum flow rate FRmax (upper limit value) and 0% for the position of the valve body 21 when the valve body 21 is in contact with the valve hole 62.

In FIG. 9, periods from time T0 to time T1, from time T2 to time T4, and on and after time T5 are periods in which the bubble detecting unit 33 is detecting the absence of an abnormal state. In contrast, in FIG. 9, periods from time T1 to Time T2 and time T4 to time T5 are periods in which the bubble detecting unit 33 is detecting the presence of an abnormal state.

Further, in the period from time T0 to time T3, the set flow rate value FRset1 corresponding to the opening of 20% of the valve body 21 is set as the set flow rate value FRset, and in the period on and after time T3, the set flow rate value FRset2 corresponding to the opening of 70% of the valve body 21 is set as the set flow rate value FRset,

As illustrated in FIG. 9, the control unit 31 controls the flow rate adjusting portion 20 to perform the flow rate adjusting operation in the period in which the bubble detecting unit 33 is detecting the absence of an abnormal state. In this period, the control unit 31 adjusts the position of the valve body 21 to be maintained at the opening of 20% corresponding to the set flow rate value FRset1.

Further, as illustrated in FIG. 9, in the period from time T1 to time T2 in which the bubble detecting unit 33 is detecting the presence of an abnormal state, the control unit 31 increases the opening of the valve body 21 to an opening larger than the opening of 20% corresponding to the set flow rate valve FRset1. This is for facilitating bubbles to be released from the measurement flow channel 14 and prompting the abnormal state to be resolved.

Similarly, as illustrated in FIG. 9, in the period from time T4 to time T5 in which the bubble detecting unit 33 is detecting the presence of an abnormal state, the control unit 31 increases the opening of the valve body 21 to an opening larger than the opening of 70% corresponding to the set flow rate valve FRset2. This is for facilitating bubbles to be released from the measurement flow channel 14 and prompting the abnormal state to be resolved.

Note that the increase rate of the opening of the valve body 21 from the opening of 20% corresponding to the set flow rate valve FRset1 in the period from time T1 to time T2 is larger than the increase rate of the opening of the valve body 21 from the opening of 70% corresponding to the set flow rate valve FRset2 in the period from time T4 to time T5. This is for setting a longer predetermined distance D by which the valve body 21 is moved for a smaller set flow rate value FRset applied at detection of the presence of an abnormal state and thereby suitably eliminating a phenomenon in which the opening of the valve body 21 becomes smaller for a smaller set flow rate value FRset and this makes bubbles less likely to be released from the measurement flow channel 14.

The effects and advantages achieved by the flow rate adjusting device 100 of the present embodiment described above will be described.

According to the flow rate adjusting device 100 of the present embodiment, in response to the bubble detecting unit 33 detecting the presence of an abnormal state where the ultrasonic flow metering portion 10 is unable to perform the flow rate measuring operation due to bubbles present in the measurement flow channel 14, the valve body 21 is moved by the predetermined distance D in the direction away from the valve hole 62, and the motion of the valve body 21 is then stopped. Since the opening of the valve body 21 is larger than the opening at the time of detection of the presence of the abnormal state, release of bubbles from the measurement flow channel 14 is facilitated compared to a case where the opening of the valve body 21 at the time of detection of the presence of the abnormal state is maintained, and the abnormal state can be quickly eliminated. Further, since the opening of the valve body 21 is set regardless of a measurement result provided by the ultrasonic flow metering portion 10, it is possible to prevent a flow rate fluctuation from occurring due to an excessive increase in the opening of the valve body 21 relative to the set flow rate value FRset.

According to the flow rate adjusting device 100 of the present embodiment, the predetermined distance D becomes longer for a smaller set flow rate value FRset applied at detection of the presence of an abnormal state, and this makes it possible to suitably eliminate the phenomenon in which the opening of the valve body 21 is smaller for a smaller set flow rate value FRset and this makes bubbles less likely to be released from the measurement flow channel 14.

According to the flow rate adjusting device 100 of the present embodiment, the valve body 21 is moved by a predetermined distance D in the direction away from the valve hole 62 when the set flow rate value FRset applied at detection of the presence of an abnormal state is less than or equal to a predetermined value, and this makes it possible to suitably eliminate the phenomenon in which the opening of the valve body 21 is small for the set flow rate value FRset less than or equal to the predetermined value and this makes bubbles less likely to be released from the measurement flow channel 14.

What is claimed is:

1. A flow rate adjusting device comprising:
an ultrasonic flow metering portion configured to perform a flow rate measuring operation to measure a flow rate of a liquid flowing through a measurement flow channel based on a propagation time difference between ultrasonic waves oscillated by a pair of oscillators arranged upstream and downstream in the measurement flow channel, the liquid flowing through the measurement flow channel;
a flow rate adjusting portion configured to move a valve body along an axis in a direction closer to or away from a valve hole to adjust a flow rate of a liquid flowing out of the measurement flow channel;
a flow rate setting unit configured to set a set flow rate value of a liquid to be adjusted by the flow rate adjusting portion;
a control unit configured to control the flow rate adjusting portion to perform a flow rate adjusting operation to move the valve body to a target position so that a measured flow rate value of a liquid measured by the ultrasonic flow metering portion is the set flow rate value, the target position varying in accordance with a flow rate difference between the measured flow rate value and the set flow rate value; and
an anomaly detecting unit configured to detect whether or not there is an abnormal state where the ultrasonic flow metering portion is unable to perform the flow rate measuring operation due to a bubble present in the measurement flow channel,
wherein in response to the anomaly detecting unit detecting presence of the abnormal state, the control unit controls the flow rate adjusting portion to move the valve body by a predetermined distance in a direction away from the valve hole and then stop the valve body.

2. The flow rate adjusting device according to claim 1, wherein the control unit controls the flow rate adjusting portion to stop performing the flow rate adjusting operation in response to the anomaly detecting unit detecting presence of the abnormal state and start performing the flow rate adjusting operation in response to the anomaly detecting unit detecting absence of the abnormal state.

3. The flow rate adjusting device according to claim 1, wherein the control unit controls the flow rate adjusting portion so that the predetermined distance is longer as the set flow rate value set by the flow rate setting unit is smaller when the anomaly detecting unit detects presence of the abnormal state.

4. The flow rate adjusting device according to claim 1, wherein when the set flow rate value set by the flow rate setting unit is less than or equal to a predetermined value in response to the anomaly detecting unit detecting presence of the abnormal state, the control unit controls the flow rate adjusting portion to move the valve body by the predetermined distance in the direction away from the valve hole and then stop the valve body, and when the set flow rate value set by the flow rate setting unit is greater than the predetermined value in response to the anomaly detecting unit detecting presence of the abnormal state, the control unit controls the flow rate adjusting portion to stop the valve body without moving the valve body in the direction away from the valve hole.

5. A control method of a flow rate adjusting device, wherein the flow rate adjusting device comprises
an ultrasonic flow metering portion configured to perform a flow rate measuring operation to measure a flow rate of a liquid flowing through a measurement flow channel based on a propagation time difference between ultrasonic waves oscillated by a pair of oscillators arranged upstream and downstream in the measurement flow channel, the liquid flowing through the measurement flow channel,
a flow rate adjusting portion configured to move a valve body along an axis in a direction closer to or away from a valve hole to adjust a flow rate of a liquid flowing out of the measurement flow channel, and
a flow rate setting unit configured to set a set flow rate value of a liquid to be adjusted by the flow rate adjusting portion,
the control method comprising:
a flow rate adjusting step of controlling the flow rate adjusting portion to perform a flow rate adjusting operation to move the valve body to a target position so that a measured flow rate value of a liquid measured by the ultrasonic flow metering portion is the set flow rate value, the target position varying in accordance with a flow rate difference between the measured flow rate value and the set flow rate value;
an anomaly detecting step of detecting whether or not there is an abnormal state where the ultrasonic flow metering portion is unable to perform the flow rate measuring operation due to a bubble present in the measurement flow channel; and
a bubble releasing step of, in response to the anomaly detecting step detecting presence of the abnormal state, controlling the flow rate adjusting portion to move the valve body by a predetermined distance in a direction away from the valve hole and then stop the valve body.

6. The control method of the flow rate adjusting device according to claim 5 further comprising a flow rate adjustment suspending step of stopping performing the flow rate adjusting operation in response to the anomaly detecting step detecting presence of the abnormal state,
wherein the flow rate adjusting step starts performing the flow rate adjusting operation in response to the anomaly detecting step detecting absence of the abnormal state.

7. The control method of the flow rate adjusting device according to claim 5, wherein the bubble releasing step controls the flow rate adjusting portion so that the predetermined distance is longer as the set flow rate value set by the flow rate setting unit is smaller when the anomaly detecting step detects presence of the abnormal state.

8. The control method of the flow rate adjusting device according to claim 5, wherein when the set flow rate value set by the flow rate setting unit is less than or equal to a predetermined value in response to the anomaly detecting step detecting presence of the abnormal state, the bubble releasing step controls the flow rate adjusting portion to move the valve body by the predetermined distance in the direction away from the valve hole and then stop the valve body, and when the set flow rate value set by the flow rate setting unit is greater than the predetermined value in response to the anomaly detecting step detecting presence of the abnormal state, the bubble releasing step controls the flow rate adjusting portion to stop the valve body without moving the valve body in the direction away from the valve hole.
